(19) United States
(12) Patent Application Publication
(10) Pub. No.: US 2013/0039049 A1
(43) Pub. Date: Feb. 14, 2013

(54) MOBILE LIGHT TOWER

(71) Applicants: Paul Michael Jones, Dudley (GB); David Gary Timmins, Coleshill (GB)

(72) Inventors: Paul Michael Jones, Dudley (GB); David Gary Timmins, Coleshill (GB)

(73) Assignees: David G. Timmins, Coleshill (GM); Paul M. Jones, Dudley (GB)

(21) Appl. No.: 13/568,527

(22) Filed: Aug. 7, 2012

(30) Foreign Application Priority Data
Aug. 9, 2011 (GB) 1113704.9

(51) Int. Cl. F21L 4/02; F21V 21/00

(52) U.S. Cl. 362/184; 362/249.07

(57) ABSTRACT

A mobile light tower (1) comprising a base unit (2) and at least one light (4a, 4b) connected to the base unit by an extendable mast (5), the base unit including a power source for powering the at least one light, the extendable mast (5) adapted to move between a retracted position and an extended position, wherein the mobile light tower includes a controller (6) and a wind speed sensor (7), the controller adapted to lower the extendable mast to an intermediate position, between the retracted position and extended position, when the wind speed sensor (7) determines that a predetermined wind speed is exceeded.

### CROSS-REFERENCE

This application is based on and claims priority from GB 1113704.9, filed on Aug. 9, 2011, with the UK Intellectual Property Office. The aforementioned patent application contains subject matter related, in certain aspects, to the subject matter of the present invention. The disclosure of this patent application is therefore incorporated by reference in the specification of the present invention.

### FIELD OF THE INVENTION

This invention relates to a mobile light tower. It also relates to a controller for a mobile light tower.

### BACKGROUND OF THE INVENTION

Mobile light towers comprise a base, an extendable mast and a light rig to which lighting units are mounted. The base typically comprises a power source mounted on a wheeled trailer, which can be towed by a vehicle. The light rig is connected to the base by the extendable mast, which can raise the light rig to a predetermined height above the base.

A problem with mobile light towers is that they can be unstable in high winds. The mobile light tower may be tipped over by winds which can cause damage to the light tower and also cause serious injury to people nearby. Further, when operating in windy conditions, a large area around the light tower can be potentially hazardous because the extendable mast can be of a substantial height, and therefore, if the mobile light tower is tipped, the light rig can strike the ground far from the base. It is known to improve the stability of mobile light towers using outrigger jacks that extend from the base to provide additional support.

### BRIEF SUMMARY OF THE INVENTION

According to a first aspect of the invention, we provide a mobile light tower comprising a base unit and at least one light connected to the base unit by an extendable mast, the base unit comprising a power source for powering the at least one light, the extendable mast adapted to move between a retracted position and an extended position, wherein the mobile light tower comprises a controller and a wind speed sensor, the controller adapted to lower the extendable mast when the wind speed sensor determines that a predetermined wind speed is exceeded. If the predetermined wind speed is exceeded, the controller may lower the mast to an intermediate position between the retracted position and extended position, or to the fully retracted position.

This is advantageous because the mobile light tower can be made safe in windy conditions by lowering the extendable mast. It will be appreciated that the mobile light tower is less susceptible to the effects of wind when the extendable mast and light are lowered because when the mast is lowered, there is less surface area for wind to push against, in addition to the center of gravity of the mobile light tower being lower. The mobile light tower can react to adverse weather conditions that could pose a safety risk, resulting in the lowering of the extendable mast in high winds. Thus, the controller improves the safety of operating the mobile light tower.

Preferably the mobile light tower comprises a light rig, which comprises the at least one light and provides a mounting point between the light(s) and the extendable mast. This is advantageous as the light rig provides a convenient mounting point for elements mounted at the top of the mast.

Preferably the extendable mast is telescopic. The extendable mast may be raised and lowered by a hydraulic drive unit, a winch system, or any other suitable means. It will be recognized that any other suitable method of assembling the mast other than telescopically is also included within the scope of the invention.

Preferably the wind speed sensor is mounted at the top of the extendable mast, distal the base unit. Preferably, the wind speed sensor is connected to the light rig. This is advantageous as the wind speed sensor can measure the wind speed experienced by the light(s) at its elevated position. It will be recognized that any other suitable placement of the wind speed sensor is also included within the scope of the invention.

The controller may be adapted to lower the extendable mast to an intermediate position, between the retracted position and the extended position, when a predetermined wind speed, e.g., a first predetermined wind speed, is detected by the wind speed sensor. The controller may be adapted to further lower the extendable mast from the intermediate position when the wind speed sensor determines a second predetermined wind speed or an nth predetermined wind speed is exceeded. This is advantageous as it helps the mobile light tower operate safely and remain operational. In particular, when in the fully extended position, the lighting rig will typically experience the highest winds. A given wind force acting on a fully extended mast also applies the most leverage to the base unit. Thus, the controller can lower the light rig to a lower position where the wind may be slower and the lighting rig applies less leverage to the base unit. If the wind persists and the second or nth predetermined wind speed is exceeded, the extendable mast may be lowered further or to the fully retracted position.

The second predetermined wind speed may be the same as or different from (i.e. higher or lower than) the first predetermined wind speed. This is advantageous as the controller may determine that safe operating conditions are still not experienced at the lower position, and therefore lower the extendable mast further. Since the mobile lighting tower may be able to operate safely in higher wind speeds when in the lower position, the second predetermined wind speed may be higher than the first predetermined wind speed. This allows the mobile lighting tower to be operational and safe during windy conditions.

The height of the lower intermediate position may be determined based on the wind speed detected by the wind speed sensor. This is advantageous as the controller can lower the light further when the wind speed is higher to maintain a stable mobile lighting tower.

The controller may be arranged to determine that the first predetermined wind speed and/or second predetermined wind speed has been exceeded when the wind speed sensor detects a wind speed in excess of the respective first or second predetermined wind speed for a preset amount of time. For example, in one embodiment, if a wind speed exceeds its predetermined limit for more than 5 seconds, it may cause the controller to lower the extendable mast. This is advantageous as the controller can distinguish between short gusts of wind that do not pose a safety concern and a sustained wind speed which may unsettle the mobile light tower.

The mobile light tower may also comprise an inclination sensor arranged to measure the inclination of the base unit. The controller may be arranged to check whether the base unit is level before allowing the extendible mast to be raised. The controller may prevent raising the extendable mast in response to an indication that the base is non-level. Alternatively or in addition, the controller may be adapted to lower the extendable mast when a change in the inclination is detected by the inclination sensor. This is advantageous as the controller can determine if the base unit is located on level ground, being moved or unsettled by high winds, or has moved due to unstable ground. The controller can use information from the wind speed sensor and the inclination sensor to determine when and how much to raise and lower the extendable mast to maintain safety and operation of the at least one light.

The light tower, for example, the base unit, may also include a movement sensor to detect how much the wind acting on the at least one light is affecting the base unit to determine whether or not to lower the extendable mast.

The light rig may be arranged to reposition the at least one light depending on the height of the extendable mast. This is advantageous as if the lights were in a fixed position when the extendable mast was lowered, they would illuminate a smaller area at ground level. The light rig is thus able to reposition the lights when the extendable mast is lowered or raised to maintain a particular area of illumination. This may involve rotating the light or lights outwards (away from the mast) when the extendable mast is lowered and rotating the lights inward (towards the mast) when the extendable mast is raised.

According to a second aspect of the invention, we provide a controller for a mobile light tower, the mobile light tower being of the type comprising a base unit and at least one light connected to the base unit by an extendable mast, the base unit including a power source for powering the at least one light, the extendable mast adapted to move between a retracted position and an extended position, wherein the controller comprises a wind speed sensor and is adapted to lower the extendable mast when the wind speed sensor determines that a predetermined wind speed (e.g., first, second, nth) is exceeded. When it is determined that the predetermined wind speed has been exceeded, the controller may lower the mast to an intermediate position between the retracted position and extended position. Alternatively, the controller may lower the mast to the retracted position.

It will be appreciated that the optional features described herein above with respect to the first aspect of the invention can apply equally to the controller as with respect to the second aspect of the invention in so far as it provides control of the mobile light tower.

### BRIEF DESCRIPTION OF THE SEVERAL VIEWS OF THE DRAWINGS

There now follows by way of example only a detailed description of the present invention with reference to the accompanying drawings, in which:

FIG. 1 shows a side view of an embodiment of the mobile light tower with the extendable mast in the extended position;

FIG. 2 shows a side view of an embodiment of the mobile light tower with the extendable mast in the retracted position; and

FIG. 3 shows an embodiment view of a controller.

The drawings are merely schematic representations, not intended to portray specific parameters of the invention. The drawings are not necessarily to scale. The drawings are intended to depict only typical embodiments of the invention, and therefore should not be considered as limiting the scope of the invention.

### DETAILED DESCRIPTION OF THE INVENTION

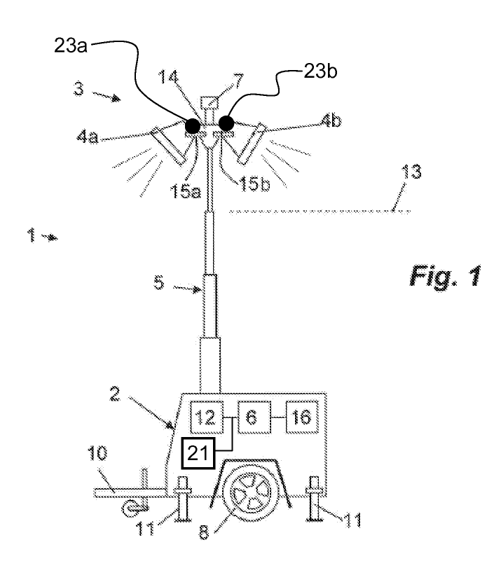

FIG. 1 shows an embodiment of a mobile light tower 1 for use on building sites, roadworks, or car parks, for examples. The mobile light tower is set up to provide illumination of an area so that a workforce can operate at night or car park users can find their cars more easily. It will be appreciated that these are only examples and the mobile light tower has many other uses.

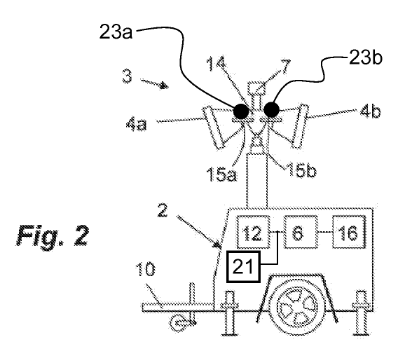

The mobile light tower 1 may comprise a base unit 2 and a light rig 3 including at least one light, for example, lights 4a and 4b. In some embodiments, more or fewer than two lights may be provided. The light rig 3 is connected to the base unit 2 by an extendable mast 5. The base unit 2 includes a power source 21 comprising, for example, a diesel powered generator for generating electricity for powering the lights 4a, 4b. The extendable mast 5 is adapted to move between a retracted position (shown in FIG. 2) and an extended position (shown in FIG. 1). The mobile light tower 1 includes a controller 6 and wind speed sensor 7, the controller 6 adapted to lower the extendable mast 5 when the wind speed sensor 7 measures that a predetermined wind speed, for example, a first predetermined wind speed, is exceeded.

The base unit 2 may comprise a wheeled trailer having wheels 8 and a towing connector 10 for connecting to a vehicle. The power source 21 may be mounted to the wheeled trailer and may be of conventional design. The base unit 2 may further comprise outrigger jacks 11 that typically extend substantially horizontally outward from the base unit and contact the ground to provide additional stability for the base unit.

The extendable mast 5 may extend from the base unit 2, and comprise a plurality of telescoped sections. The extendable mast 5 is raised and lowered by, for example, a mast motor 12 controlled by the controller 6. The mast motor 12 may comprise, for example, a hydraulic system to telescope the extendable mast 5 to its extended position and to withdraw it to its retracted position. The mast motor may alternatively comprise a winch or any other suitable alternative.

The mast motor 12 can move the extendable mast to positions between the retracted position and the extended position. The dashed line 13 represents a non-limiting example of the height of the light rig 3 when the extendable mast 5 is in an intermediate position. In some embodiments, the extended position is around nine meters above the ground. The intermediate position may, in some embodiments, be between three and nine meters, such as 4, 5, 6, 7 or 8 meters or within ranges thereof. Alternatively, the intermediate position may be defined as a fraction of the fully extended height, such as ¾, ⅔ or ½ the fully extended height or ranges thereof. It will be recognized that the examples of intermediate position height are for purposes of providing a complete disclosure, and that any suitable intermediate height is included within the scope of the invention.

The light rig 3 may comprise a hub 14 connected atop the extendable mast 5. The hub 14 may include brackets for each of the at least one light, for example, brackets 15a and 15b, which connect the lights 4a and 4b, respectively, to the hub 14. It will be recognized that any other suitable means for connecting the at least one light (e.g., lights 4a and 4b) to the hub 14 are included within the scope of the invention. The at least one light, for example, lights 4a and 4b, may comprise a metal halide lamp, as is known in the art, or any other suitable alternative. The hub 14 may also provide a mounting point for the wind speed sensor 7. The wind speed sensor 7 is arranged to relay its measurement data to the controller 6 either wirelessly, through a communication line that runs along the extendable mast 5, or through any other suitable means.

The brackets 15a, 15b may include means, for example, motorized swivel joints 23a and 23b, to reposition the direction that the lights 4a and 4b point. The motorized swivel joints 23a and 23b may be arranged to receive repositioning instructions from controller 6 either wirelessly, through a communication line that runs along the extendable mast 5, or through any other suitable means. This is advantageous as the at least one light (lights 4a and 4b) can be positioned such that the ground area illuminated by the mobile light tower may remain substantially constant with changes in height of the extendable mast 5 and, in particular, when the extendable mast 5 is moved between the extended position and the intermediate position. As can be seen in FIG. 2 compared to FIG. 1, the angle of the lights has been adjusted outwardly with the reduction in the height of the extendable mast 5.

FIG. 1 shows the mobile light tower 1 with the extendable mast 5 in the extended position. The extended position is typically the substantially full extension of the extendable mast. FIG. 2 shows the extendable mast 5 in the substantially retracted position, which is typically fully retracted such that the mobile light tower is ready for transport.

In use, the mobile light tower 1 is positioned where it is needed, typically by towing it to the position or through any other suitable means. It is unhitched from the towing vehicle (not shown) and the outrigger jacks 11 may be extended and lowered. The extendable mast 5 is extended from the retracted position, which may be adopted during transport of the mobile light tower 1, to the fully extended position (or some other suitable height). The mobile light tower 1 can therefore provide light to the required area. The controller 6 is arranged to monitor the wind speed detected by the wind speed sensor 7. If the wind speed is lower than a predetermined speed, for example, a first predetermined wind speed, the extendable mast 5 is maintained in the extended position. In this embodiment, the first predetermined speed is 70 miles per hour (31 meters per second). If the controller 6 measures a wind speed in excess of the predetermined speed, e.g., 72 miles per hour, (which may be the highest wind speed for safe operation) it is arranged to actuate the mast motor 12 to lower the extendable mast 5. This reduces the risk of the mobile light tower 1 toppling over.

In an alternative embodiment, the controller 6 is arranged to determine that the first predetermined wind speed has been exceeded if the wind speed sensor 7 measures a wind speed in excess of the first predetermined speed for a predetermined period of time, which in this embodiment is 10 seconds. Once the controller 6 determines that this has occurred, the extendable mast is lowered.

In some embodiments, there may be more than one predetermined wind speed (e.g., first, second, nth), each comprising a threshold for further lowering the mast 5. In the above-described embodiments, the controller 6 is adapted to lower the extendable mast 5 to an intermediate position. The controller 6 is programmed to lower the extendable mast to the intermediate position and to continue monitoring the wind speed using the wind speed sensor 7 at the intermediate position. If the controller 6 determines that the wind speed is above a second predetermined wind speed (or above the second predetermined wind speed for a predetermined period of time), the controller 6 may actuate the mast motor 12 to lower the extendable mast 5 further or fully to the retracted position. The second predetermined wind speed in this example is the same as the first predetermined speed. In some embodiments, the second predetermined wind speed may be greater or less than the first predetermined wind speed. As the intermediate position is lower than the extended position, the second predetermined wind speed may be higher than the first predetermined wind speed because wind catching the light rig 3 will usually apply less leverage to the base unit 2 when the extendable mast 5 is lower. For example, the second predetermined wind speed may be 80 miles per hour (35.8 meters per second).

In some embodiments, the controller may be arranged to raise the mast 5 back towards extended position (either an intermediate height or fully extended) when the wind speed returns to a value below the predetermined first, second, or nth predetermined wind speed, etc.

In a further embodiment, the controller 6 is also arranged to receive information from an inclination or movement sensor 16. The inclination sensor may measure the inclination of the base unit 2 to the ground to determine if it is being tipped over by high winds. Thus, when the controller detects an inclination of more than a predetermined value, for example, two degrees, it may lower the mast. Similarly the movement sensor 16 may measure how much the base unit is being moved by the wind to see if the mobile lighting tower 1 is being unsettled by the wind. The movement sensor may be, for example, an accelerometer, and if it measures acceleration above a predetermined threshold, the controller may lower the mast 5. The controller 6 may use information from the wind speed sensor 7 and inclination/movement sensor 16 when determining when and by how much to lower the extendable mast 5. The controller 6 may use the inclination/movement sensor independently of the wind speed sensor 7 to decide when to lower the mast. Although the movement and inclination sensor is shown herein as a single sensor, in some embodiments, they may be configured as separate sensors, e.g., a movement sensor and an inclination sensor.

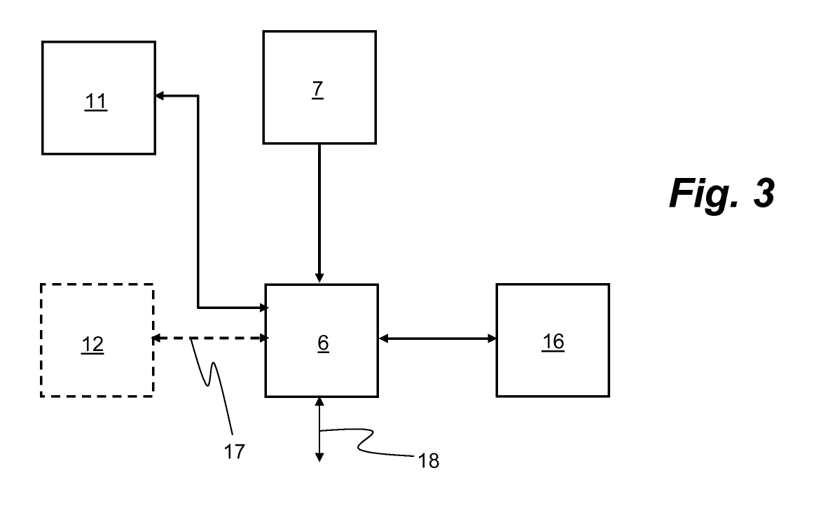

FIG. 3 shows a diagram of a controller 6, with wind speed sensor 7 and inclination/movement sensor 16. The controller 6 is configured and disposed to access memory 11. Memory 11 contains instructions, which, when executed by the controller 6, perform the operations of controlling the height of the extendable mast 5 based on input from the wind speed sensor 7. The memory 11 may be non-transitory, and may comprise any suitable technology, including, but not limited to, read-only memory (ROM), flash, or an optical storage technology. The controller 6 may be retrofitted to existing mobile lighting towers to provide an additional safety feature. The controller is shown having a connection 17 to a mast motor of the mobile lighting tower that can control the height of the extendable mast 5. It will be appreciated that the controller may have programming port 18 to receive additional information to calibrate the controller 6 to the mobile light tower 1. For example, the output necessary to actuate the mast motor 12 may be programmed via the programming port 18. Further, the controller 6 may be arranged to receive further sensor inputs or an extendible mast position signal, so that the position of the mast can be precisely controlled.

It will be appreciated that the first predetermined wind speed, second predetermined wind speed, and any other (third, fourth, etc.) predetermined wind speeds, may be any speed appropriate to ensure the stability and safety of the mobile light tower. For conventional mobile light towers, the safe operating speed when the mast is at full extension is between 65 and 75 miles per hour (29 to 33.5 meters per second), and therefore the predetermined speed may be set to this value. When the mast 5 is in the intermediate position 13, the second predetermined speed may be the same or 5%, 10% or 15% higher or more, as non-limiting examples. The controller may be adapted to fully lower the extendible mast 5 when the predetermined wind speed is detected. The height of the intermediate position may be determined from the wind speed detected by the wind speed sensor 7. For example, the controller may include a table (for example, Table 1 below) of different mast heights and the safe wind speed for operating the light tower at each height. When the wind speed sensor detects a wind speed above the first predetermined amount or second predetermined amount, the controller 6 may refer to the look up table to identify the height of the intermediate position for continued operation at the wind speed detected.

TABLE 1

| Wind Speed | Height |
|---|---|
| A | X |
| B | Y |

The foregoing description of various aspects of the invention has been presented for purposes of illustration and description. It is not intended to be exhaustive or to limit the invention to the precise form disclosed, and many modifications and variations are possible. Such modifications and variations that may be apparent to a person skilled in the art are intended to be included within the scope of the invention as defined by the accompanying claims.

1. A mobile light tower comprising a base unit and at least one light connected to the base unit by an extendable mast, the base unit including a power source for powering the at least one light, the extendable mast adapted to move between a retracted position and an extended position, wherein the mobile light tower includes a controller and a wind speed sensor, the controller adapted to lower the extendable mast to an intermediate position, between the retracted position and extended position, when the wind speed sensor determines that a first predetermined wind speed is exceeded.

2. The mobile light tower of claim 1, further comprising a light rig, the light rig comprising the at least one light and a mounting point between the at least one light and the extendable mast.

3. The mobile light tower of claim 1, wherein the extendable mast is telescopic.

4. The mobile light tower of claim 1, wherein the wind speed sensor is mounted on the extendable mast, distal the base unit.

5. The mobile light tower of claim 4 further comprising a light rig, the light rig comprising the at least one light and a mounting point between the at least one light and the extendable mast, and wherein the wind speed sensor is connected to the light rig.

6. The mobile light tower of claim 1, wherein the controller is adapted to lower the extendable mast from the intermediate position when the wind speed sensor determines a second predetermined wind speed is exceeded.

7. The mobile light tower of claim 6 wherein the second predetermined wind speed is the same as or higher than the first predetermined wind speed.

8. The mobile light tower of claim 1, wherein the intermediate position is determined based on the wind speed detected by the wind speed sensor.

9. The mobile light tower of claim 1, wherein the controller is arranged to determine that the first predetermined wind speed has been exceeded when the wind speed sensor detects a wind speed in excess of the first predetermined speed for a preset amount of time.

10. The mobile light tower of claim 1 further comprising an inclination sensor arranged to measure inclination of the base unit.

11. The mobile light tower of claim 10, wherein the controller is arranged to check whether or not the base unit is level before allowing the extendable mast to be raised.

12. The mobile light tower of claim 10, wherein the controller is adapted to lower the extendable mast when a change in the inclination is detected by the inclination sensor.

13. The mobile light tower of claim 1, wherein the base unit comprises a movement sensor to detect how much the wind acting on the light is affecting the base unit to determine whether to lower the extendable mast.

14. The mobile light tower of claim 2, wherein the light rig is arranged to reposition the at least one light depending on the height of the extendable mast.

15. A mobile light tower comprising a base unit and at least one light connected to the base unit by an extendable mast, the extendable mast adapted to move between a retracted position and an extended position, wherein the mobile light tower includes a controller, non-transitory memory, and a wind speed sensor, wherein the non-transitory memory contains instructions, that when executed by the controller, lower the extendable mast to an intermediate position, between a retracted position and a fully extended position, in response to an indication that a first predetermined wind speed is exceeded.

16. The mobile light tower of claim 15, wherein the non-transitory memory contains instructions, that when executed by the controller, lower the extendable mast from the intermediate position to the retracted position in response to an indication that a second predetermined wind speed is exceeded.

17. The mobile light tower of claim 15, wherein the non-transitory memory contains instructions, that when executed by the controller, prevent raising the extendable mast in response to an indication that the base unit is non-level.

18. The mobile light tower of claim 15, wherein the non-transitory memory contains instructions, that when executed by the controller, lower the extendable mast in response to an indication that the first predetermined wind speed is exceeded for a preset amount of time.

19. The mobile light tower of claim 15, wherein the non-transitory memory contains instructions, that when executed by the controller, lower the extendable mast in response to a change in inclination detected by an inclination sensor.

20. A mobile light tower comprising a base unit and at least one light connected to the base unit by an extendable mast, the extendable mast adapted to move between a retracted position and an extended position, wherein the mobile light tower includes a controller, non-transitory memory, and an inclination sensor, wherein the non-transitory memory contains instructions, that when executed by the controller, lower the extendable mast to an intermediate position, between a retracted position and a fully extended position, in response to a change in inclination detected by the inclination sensor.
